(19) United States
(12) Patent Application Publication
(10) Pub. No.: US 2003/0134071 A1
(43) Pub. Date: Jul. 17, 2003

(54) Adhesive strip for suspension

(76) Inventor: Jui-Chan Sung, Taichung (TW)

Correspondence Address: Rosenberg, Klein & Lee, Suite 101, 3458 Ellicott Center Drive, Ellicott City, MD, 21043, US

(21) Appl. No.: 10/045,143

(22) Filed: Jan. 15, 2002

(51) Int. Cl. B32B 7/06

(52) U.S. Cl. 428/40.1; 428/354; 428/119

(57) ABSTRACT

An adhesive strip (10) for suspension is made of flexible material and comprises a base plate (11), at least one fin (12) formed on the base plate (11) and an adhesive layer coated on one side of the base plate (11). The adhesive strip (10) can be easily divided into pieces and attached to flat surfaces or objects respectively, wherein the fins (12) of two paired adhesive strips (12) face in opposite directions and are complementary when engaged with each other. Whereby, the objects are suspended on the surface at a desired place and easily removed if the objects are wanted.

### BACKGROUND OF THE INVENTION

1. Field of the Invention

The present invention relates to an adhesive strip, and more particularly to an adhesive strip for use on flat upright surfaces to detachably suspend objects in a conventional way.

2. Description of Related Art

To decorate an area, display a collection or store items, people usually suspend objects such as clocks, paintings, ornaments or remote controls on walls or other upright surfaces. Basically, three types of suspension means are used to secure objects on desired places.

1. Hooks or Nails:

The most conventional way to hang items is attaching hooks or nails on the flat surfaces and hang the item with a hook, a hole or an eye on the attached hooks or nails. However, attaching hooks to and nailing nails into the surface is troublesome and inevitably destroys the smooth surface. Additionally, the objects suspended on the hooks or nails must have a lip, hook, eye or hanger wire to correspond to the hooks or nails.

2. Glue or Tape:

Using glue or tape to stick objects on flat surfaces is more convenient than nailing. However once attached, the objects cannot be readily detached from the flat surface. Therefore, using glue or adhesive tape is not suitable for objects used or changed often.

3. Baskets or Racks:

Although objects can be readily removed from the baskets or racks, attaching the baskets and racks to the surface is also troublesome. Besides, baskets or racks are an additional expense for decoration and waste more space in rooms.

To obviate or mitigate the problems with the conventional means of suspending objects on upright surfaces, the present invention provides an adhesive strip that is convenient to use and makes detaching the suspended objects easy.

### SUMMARY OF THE INVENTION

The main objective of the invention is to provide an adhesive strip that has a simple structure and is convenient to use.

Other advantages and novel features of the invention will become more apparent from the following detailed description when taken in conjunction with the accompanying drawings.

### BRIEF DESCRIPTION OF THE DRAWINGS

FIG. 1 is a perspective view of an adhesive strip for suspension in accordance with the present invention;

FIG. 2 is an enlarged cross sectional side plan view of the adhesive strip along part of line 2-2 in FIG. 1;

FIG. 3 is an operational perspective view of the adhesive strip in FIG. 1 used with a remote control;

FIG. 4 is a cross sectional side plan view of the adhesive strip along line 4-4 in FIG. 3;

FIG. 5 is a perspective view of one embodiment of the adhesive strip, wherein the adhesive strip has fins formed in parallel with a short edge;

FIG. 6 is a cross sectional side plan view of one embodiment of the fins the adhesive strip in accordance with the present invention, wherein each fin have an enlarged head;

FIG. 7 is a cross sectional side plan view of another embodiment of the fins the adhesive strip in accordance with the present invention, wherein each fin have a cap-head; and

FIG. 8 is a cross sectional side plan view of another embodiment of the fins the adhesive strip in accordance with the present invention, wherein each fin has a saw-toothed contact face.

### DETAILED DESCRIPTION OF THE PREFERRED EMBODIMENT

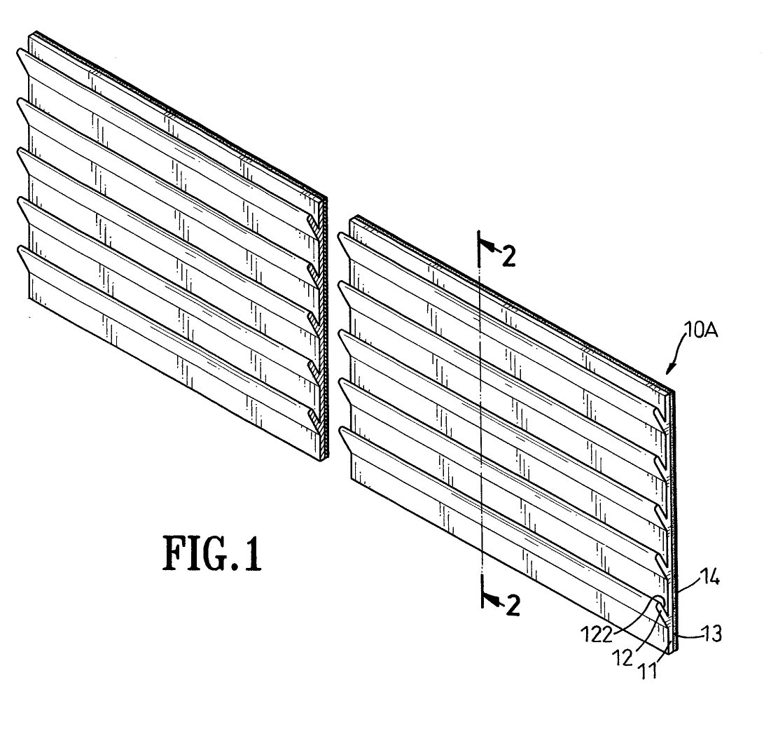

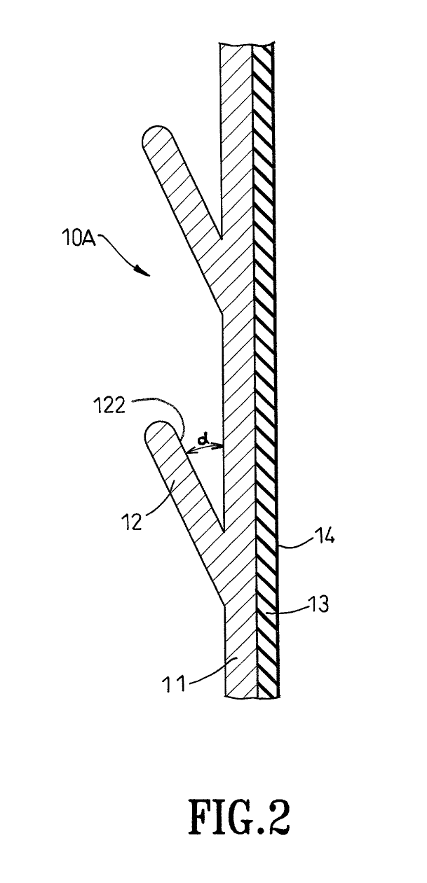

With reference to FIGS. 1 and 2 an adhesive strip (10) for suspension in accordance with the present invention is comprises a base plate (11), multiple fins (12), an adhesive layer (13) and a protective layer (14).

The base plate (11) has a long side and a short side and is made of flexible material such as rubber or plastic so that the base plate (11) can be cut into pieces of desired sizes when used. The base plate (11) is also selectively molded in different shapes and different colors to enhance the attractiveness of the adhesive strip (10).

The fins (12) are formed in parallel with the long side of the base plate (11) and are formed integrally from the base plate (11). Each fin (12) has a rough contact face (122) formed on an inner face of the fin (12), and all fins (12) are inclined in parallel in a single direction at a specific included angle (α) with the base plate (11), wherein the included angle (α) is less than 90°. The included angle (α) of the embodiment shown in FIGS. 1 and 2 is 30°.

The adhesive layer (13) is made of glue or double sided tape and is attached to the side of the base plate (11) opposite to the fins (12) so that the adhesive strip (10) can attach to flat surfaces. Additionally, the protective layer (14) covers the adhesive layer (13) before the adhesive strip (10) is used to prevent the adhesive strip (10) from sticking to other objects. Moreover, the protective layer (14) is easily separated from the adhesive layer (13) to make the adhesive strip convenient to use.

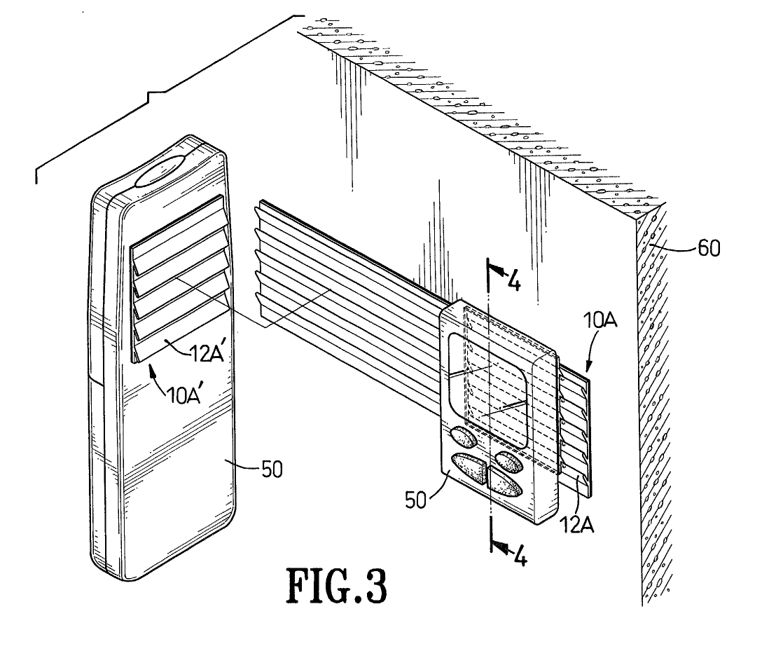

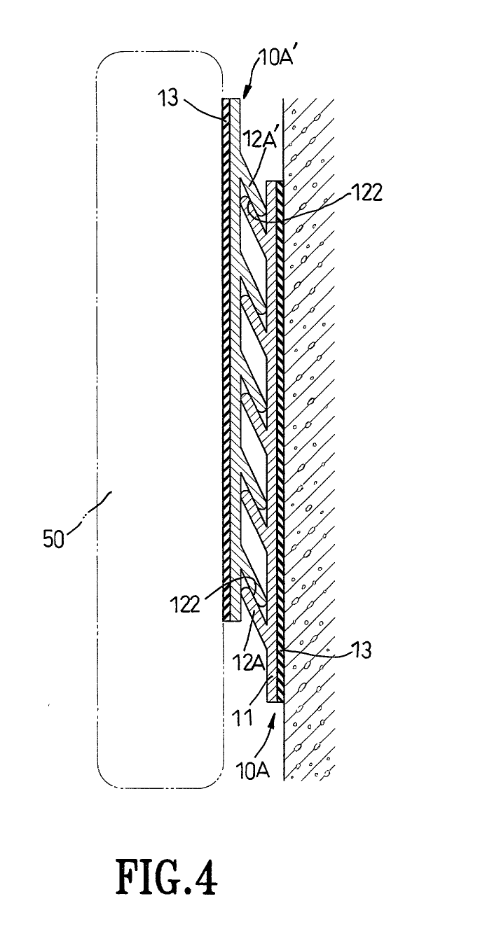

With reference to FIGS. 3 and 4, objects with which the adhesive strip (10) are used have a front and a back with a flat surface on the back. When the adhesive strip (10) is used, two pieces of the adhesive strip (10A, 10A′) are needed to engage each other. A first adhesive strip (10A) of a proper length is attached to a wall or other vertical surface with first fins (12A) on the first adhesive strip (10A) directed upward. A second adhesive strip (10A′) of a proper length is attached to the back of an object to be hung up such as a remote control (50), wherein second fins (12A′) on the second adhesive strip (10A′) are directed downward. Therefore, the first adhesive strip (10A) and the second adhesive strip (10A′) can engage each other by hooking the first fins (12A) and the second fins (12A′) together. Then, a person can readily remove the remote control (50) from the wall easily by separating the second fins (12A′) from the first fins (12A) when lifting up the remote control (50).

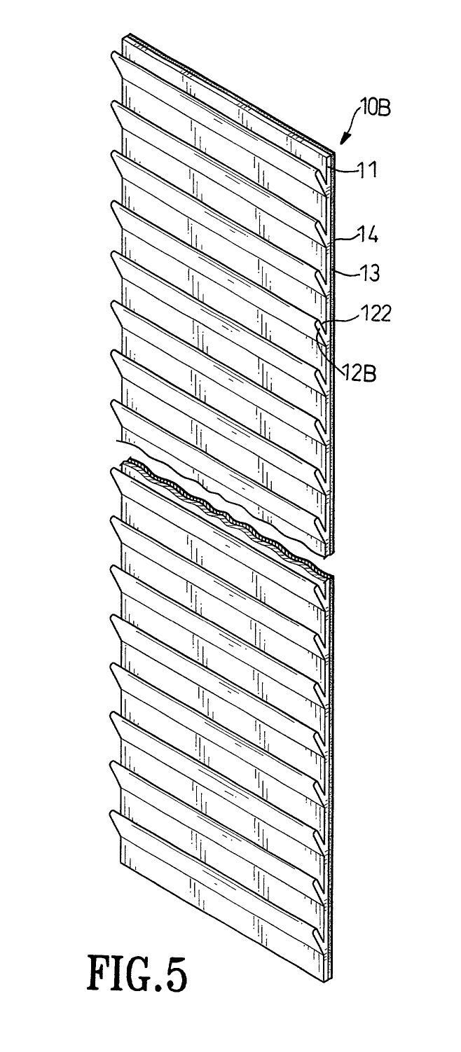

With reference to FIGS. 5-8, the arrangement and structure of the fins (12) of the adhesive strip (10) can be changed to improve the versatility of the strip (10) and the holding power of the fins (12). With reference to FIG. 5, another embodiment of the adhesive strip (10B) has the fins (12B) formed in parallel with the short edge of adhesive strip (10B). This would allow a user to vary the height of the object on the vertical surface.

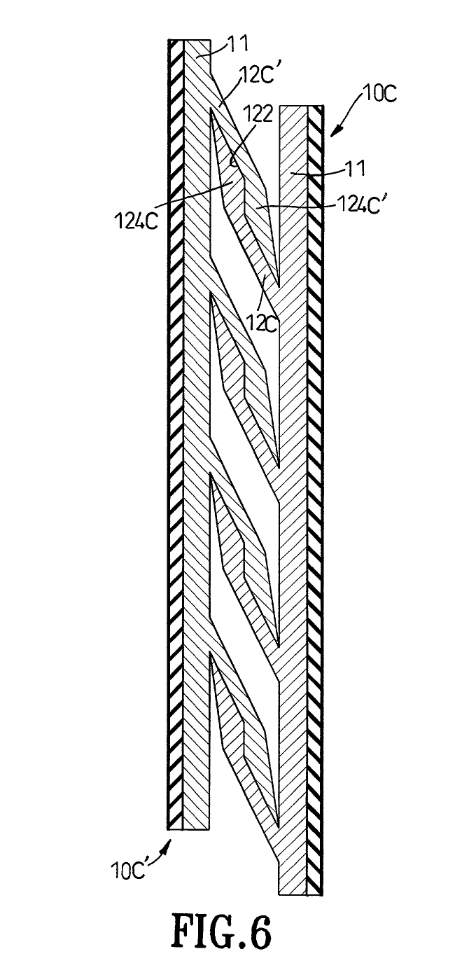

With reference to FIG. 6, another embodiment of the adhesive strip (10) has an enlarged head (124) formed on the distal end of each fin (12C). The shape of the enlarged head (124) is complementary to a corresponding fin (12C′) of the corresponding adhesive strip (10C′) so that the paired adhesive strips (10C, 10C′) have excellent holding efficiency to each other.

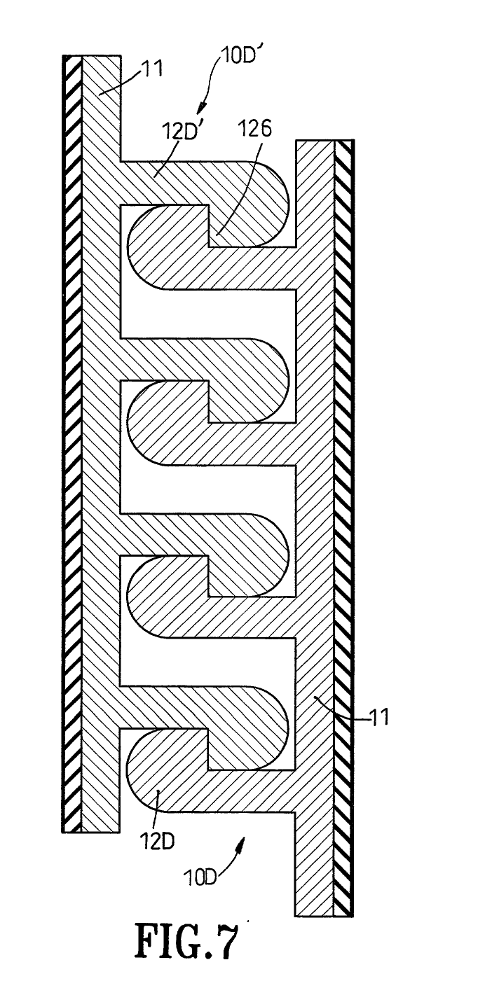

With reference to FIG. 7, each fin (12D) of another embodiment of the adhesive strip (10) has an enlarged cap-head (126) formed on the distal end of each fin (12D). The enlarged cap-head (126) will hook with a corresponding cap-head fin (12D′) on the corresponding adhesive strip (10D′). The cap-head (126) of the fin (12D) provides an excellent holding effect to the paired adhesive strips (10D, 10D′) because of a straight blocking surface (127) and that the adhesive strip (10D) has a large included angle (β, 90°) between each fin (12D) and the base plate (11).

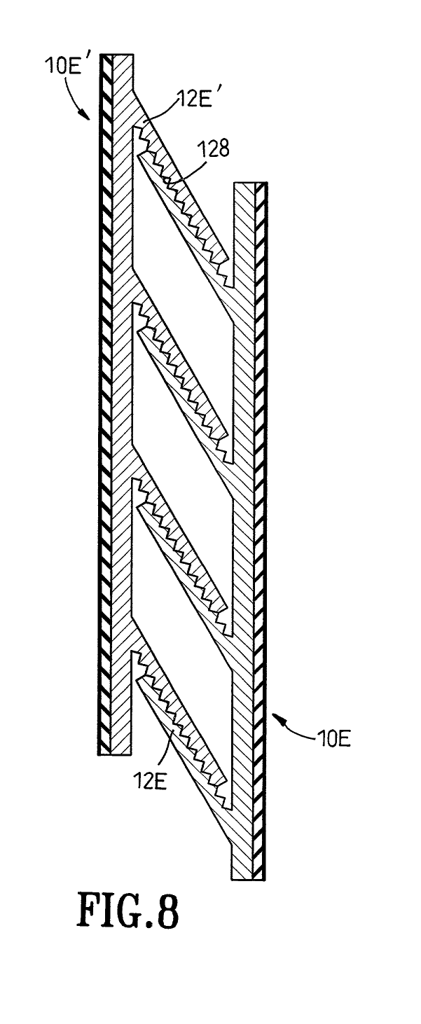

With reference to FIG. 8, each fin (12E) of another embodiment of the strip (10) has a saw-toothed contact face (128) and is complementary to a respective fin (12E′) of a corresponding adhesive strip (10E′). The toothed contact face (128) also enhances the holding efficiency of the paired adhesive strips (10E, 10E′).

The adhesive strip in accordance with the present invention has a simplified structure as described. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adhesive strip for suspension adapted to hang an object on a surface, and the adhesive strip comprising:
a base plate (11) made of flexible material;
at least one fin (12) attached to one side of the base plate (11); and
an adhesive layer (13) attached to the other side of the base plate (11) so that the adhesive strip (10) can be attached to a surface or an object, whereby an object with the adhesive strip can be hanged on a surface with a adhesive strip.

2. The adhesive strip as claimed in claim 1, wherein the base plate (11) has multiple fins (12) separated from each other and formed on the base plate (11) in parallel with each other.

3. The adhesive strip as claimed in claim 1, wherein the at least one fin (12) further has a rough contact face (122) to enhance the holding efficiency of the adhesive strip (10).

4. The adhesive strip as claimed in claim 2, wherein each fin (12) further has a rough contact face (122) to enhance the holding efficiency of the adhesive strip (10).

5. The adhesive strip as claimed in claim 1, wherein the at least one fin (12C) further has an enlarged head (124) formed on a distal end of the at least one fin (12C) to enhance the holding efficiency of the adhesive strip (10C).

6. The adhesive strip as claimed in claim 2, wherein each fin (12C) further has an enlarged head (124) formed on a distal end of each fin (12C) to enhance the holding efficiency of the adhesive strip (10C).

7. The adhesive strip as claimed in claim 1, wherein the at least one fin (12E) further has a saw-toothed contact face (128) of the at least one fin (12E) to enhance the holding efficiency of the adhesive strip (10E).

8. The adhesive strip as claimed in claim 2, wherein each fin (12E) further has a saw-toothed contact face (128) of each fin (12E) to enhance the holding efficiency of the adhesive strip (10E).

9. The adhesive strip as claimed in claim 1, wherein the at least one fin (12D) further has a cap-head (126) formed on a distal end of the at least one fin (12D) to enhance the holding efficiency of the adhesive strip (10D).

10. The adhesive strip as claimed in claim 2, wherein each (12D) further has a cap-head (126) formed on a distal end of each fin (12D) to enhance the holding efficiency of the adhesive strip (10D).

11. The adhesive strip as claimed in claim 1, wherein the adhesive layer (13) is made of glue.

12. The adhesive strip as claimed in claim 1, wherein the adhesive layer (13) is made of a double sided tape.

13. The adhesive strip as claimed in claim 11, in which a protective layer (14) covers the adhesive layer (13).

14. The adhesive strip as claimed in claim 12, in which a protective layer (14) covers the adhesive layer (13).
